(19) United States
(12) Patent Application Publication
(10) Pub. No.: US 2009/0051683 A1
(43) Pub. Date: Feb. 26, 2009

(54) METHOD AND SYSTEM FOR FOOT SHAPE GENERATION

(76) Inventors: Ravindra Stephen Goonetilleke, Kowloon (HK); Ying Kwong Tang, Hong Kong (CN); Yim Lee Au, Hong Kong (CN)

Correspondence Address: STITES & HARBISON PLLC, 1199 NORTH FAIRFAX STREET, SUITE 900, ALEXANDRIA, VA, 22314, US

(21) Appl. No.: 12/173,358

(22) Filed: Jul. 15, 2008

Related U.S. Application Data
(60) Provisional application No. 60/959,423, filed on Jul. 16, 2007.

(51) Int. Cl. G06T 15/00; H04N 5/225

(52) U.S. Cl. 345/419; 348/207.1; 348/E05.024

(57) ABSTRACT

A foot shape generation system that is based on digital photography and a database to provide three-dimensional point cloud information for footwear designers and manufacturers to realize footwear customization. The subject 102 stands on a self-contained platform equipped with cameras 601, 602, 603, 604 and a computer 104. A set of digital cameras 601, 602, 603, 604 are positioned to capture the images from different views. A special calibration jig 1401 is preferably used for the software to convert image pixel data into real world dimensions. The software also extracts the foot profiles 1509 from the images 1504 and thereafter searches for similar foot shapes from a foot shape database 1513. A real-time mean foot shape 1515 is then generated from the similar shapes, which is thereafter modified 15116 using the person's dimensions and the foot profiles obtained. The three-dimensional coordinates 1517 of the modified foot shape can then be used for shoe last-making or fitting the foot to footwear.

This application claims priority from provisional application U.S. 60/959,423, which was filed on 16 Jul. 2007.

### FIELD OF THE INVENTION

The present invention relates to a method and system for three-dimensional (3D) shape acquisition and generation from photographs or digital images. The invention will be particularly useful for the manufacture of customized footwear for which the 3D information of the human foot shape is required. The invention also relates to databases for use in such methods and a device for simulating the foot shape inside a shoe.

### BACKGROUND OF THE INVENTION

It is important for footwear to fit well as there are numerous foot injuries and problems as a result of poor fitting footwear such as blistering, chafing, bunions, tired feet and foot pain. An effective approach to make footwear fit well is to customize the footwear dimensions according to each particular wearer. Although the technology for mass customization is available for footwear manufacturers, the cost of obtaining precise foot dimensions is still very high, limiting the availability of customized footwear. A low cost and practical methodology that provides comprehensive 3D information of the foot is therefore highly desired.

Footwear customization cannot be performed without the foot dimensions. The simplest approach of matching footwear with the foot is generally known as a sizing system. Under the footwear sizing system, footwear is made based on several pre-defined sizes. Each of the standard sizes has been coded using numbers (e.g. UK 8^{1/2}, US 9, FR 42^{2/3} and JP 270 are of the same size) or characters (e.g. AAAA, AAA, AA, A, B, C, D, E, EE, EEE, EEEE etc.). Although the footwear sizing systems are simple, they do not guarantee that the footwear fits to the foot well as the standard sizes are based on only two foot dimensions of the mean foot length and width and sometimes the foot length alone. In fact, it is very common that people, especially those with wide feet, find that footwear are too narrow for the length they require, or vice verse. As a result, footwear buyers have to compromise on the required fit due to the lack of a good-fitting shoe.

Considering more foot dimensions in a sizing system will improve the situation. Hence, a better approach is to use an unlimited amount of foot dimensions to generate the same shaped footwear. Various types of systems have been developed for foot shape acquisition. Many of these systems utilize moving laser beams to scan the foot and output the foot surface point coordinates. A laser beam from an emitter is captured by a received after being reflected from the foot surface. The distance between the surface and the emitter can then be computed from the time interval. Other systems use the laser beam to highlight the cross section of the foot surface and then capture the images of each cross section to construct the foot shape. While these systems provide precise shape information, the high set up cost has limited their application in retail stores. Another drawback is that the speed of the moving laser beam cannot be at infinite speed and thus any movement on a subject whose shape is captured has to stand still for sometime. The longer the scanning time, the more likely the person and the foot will move. This will result in uncontrollable errors.

Some systems do not use the high-cost laser beams. Instead, they employ a method known as “stereo range images” which consider a series of images from different view points and then utilize a triangulation technique to compute the shape information. Generally the “stereo range images” require a large array of cameras in known locations or a movable camera taking a large amount of images, ranging from 27 to a high as 670. Both of these methods either occupy a very large space for the camera array or have a long processing time resulting in subject movement errors.

U.S. Pat. No. 3,404,468 describes a girth adjusted footwear is made of an elastically stretchable element and secured between the margins of the upper part. This enables the upper part of the footwear to be stretched by the wearer's foot so that varying widths can be accommodated.

U.S. Pat. No. 5,596,770 describes a two-ply inflatable sock with adjustable dimensions for fitting. An inflatable toe cup and heel collar positioned between the inner and outer layers in order to adapted wearer's toe region and heel region. The wearer is allowed to control the inflation of the toe cup and heel collar by manipulating finger pump and air release mechanisms so as to alter the dimension and fit of the sock.

U.S. Pat. No. 6,684,411 describes a sock-like medical apparatus with both a heel and a toe covering that would allow liquid lotion or medicine to be applied to user's foot. This allows medicine to hold within the sock and slowly releasing the medicine over a period of time.

U.S. Pat. No. 3,872,515 describes a surgical glove is made of very thin non-allergenic material such as the silicone rubbers. This glove provides a tight fit forming a skin-like sheath on the hand of the wearer.

U.S. Pat. No. 2,841,971 describes a knit stretchable and retractable hosiery. The stitch loops of which are knit of multiple monofilament synthetic torque yarns to form a stocking which has sufficient compressive or binding force on the leg to be of therapeutic value of the wearer.

### SUMMARY OF THE INVENTION

One aim of the present invention is to provide a system and a method to generate the 3D foot shape from foot profiles. Another aim of the present invention is to provide a method and system for measuring foot dimensions.

A first aspect of the present invention provides a method of generating a 3D foot shape comprising the steps of:—

taking one or more photographs of the foot,

deriving foot shape data from the one or more photographs,

comparing the foot shape data to foot shape data of one or more foot shapes in a database and selecting one or more similar foot shapes from the database; and

generating a 3D foot shape for the photographed foot based on the one or more selected foot shapes.

The inventors have noticed that regardless of foot sizes, the actual foot shapes between different subjects are actually quite similar. Thus once certain characteristics of the foot are known the complete foot shape can be matched with a foot shape in a database, or generated from the mean shape of several similar feet in the database. Preferably the comparison of the foot shapes is on shape alone and if necessary the generated 3D foot shape can later be size-adjusted to fit the size of the subject's foot.

Thus, the foot shapes in the database enable an accurate 3D shape for the foot to be generated, even though the data in the one or more photographs may be relatively limited. Furthermore, it is not necessary to take a large number of photographs from every possible conceivable angle or to use laser distance measuring techniques. With the help of a foot shape database, the present invention provides a low-cost, practical and quick solution to foot shape acquisition and generation.

Preferably the database stores more than one foot shape and associated foot shape data for each foot. The photographed foot may then be matched to the closest or several of the closest foot shapes in the database, based on the foot shape data for each. Having several different foot shapes in the database will result in a better match and a more accurate foot shape. In some preferred embodiments the database has as many as 100 or even 200 foot shapes. However it would be possible for the database only to include only one 3D foot shape. In that case that 3D foot shape is chosen automatically and used to generate the 3D foot shape for the photographed foot. Although a database with serviced foot shapes is best, even having only one foot shape in the database is advantageous because the constructed 3D model of the photographed foot can incorporate certain 3D surface data from the databases which may not be available from the 2D projections alone.

Preferably the foot shape data comprises 2D projections of the foot and the generated 3D foot shape is adjusted to fit the 2D projections. This is described in more detail below.

One preferred embodiment uses four digital cameras and a computer system. As a result, it is quite appealing from a cost and space perspective. It takes images from 4 different views in less than one second and hence foot movement during the period is quite minimal. The photographs preferably include at least a photograph of the side of the foot and at least a photograph of the bottom of the foot. In a preferred embodiment photographs are taken of the medial side, the front and the bottom of the foot. Preferably for even better accuracy, a photograph of both the lateral side and medial side of the foot are taken. Thus from a small number of photographs sufficient foot shape data is derived to match the foot to feet shape in a database.

The generated foot shape and the foot shapes in the database are preferably 3D point clouds, but other 3D models or graphic representations may be used. A 3D point cloud is a set of points in 3 dimensions (e.g. each point has three co-ordinates). The foot shapes in the database may be derived from existing measurement techniques, e.g. laser scanning, or existing foot shape databases.

The foot shapes in the database are preferably all aligned with a common axis. The foot being photographed is preferably aligned with an axis, which may be marked on the base for supporting the foot. As the axes are aligned it becomes easy to compare the foot shapes. The step of aligning the foot shapes in the database with a common axis may be carried out when the foot shapes are stored in the database (i.e. so all the records are aligned). Alternatively the step of aligning the foot shapes may be carried out after they are retrieved from the database, e.g. before comparison and/or before generation of the 3D foot shape.

The foot shapes and any dimensions in the database are preferably all scaled to a predetermined size. For example, each foot shape in the database may correspond to a real foot but scaled to a predetermined length (e.g. 300 mm), with the other dimensions scaled by the same amount. This makes all of the foot shapes easily comparable and provides a database having a large number of foot shapes, no matter the source data is from many feet of different sizes. The foot shape data derived from the photographs is preferably scaled to the same size as the foot shapes in the database, in order to allow easy comparison. The step of scaling the foot shapes and dimensions may be carried out when the foot shapes are stored in the database (i.e. so all the records are scaled). Alternatively the step of scaling the foot shapes and dimensions may be carried out after they are retrieved from the database, e.g. so the foot shapes in database have different sizes, but are scaled before comparison and/or before generation of the 3D foot shape.

The foot shape data derived from the photographs may take any appropriate form. It should be easily comparable with the foot shape data in the database and is preferably in the same format. Preferably the foot shape data is compared by a computer program or similar.

Preferably the foot shape data comprises a ‘foot shape signature’. A foot shape signature is data describing the shape of the foot and preferably comprises one or more dimensions and/or values or functions describing the shape and/or other characteristics of the foot. The foot shape signature is preferably based on one or more 2D projections of the foot.

For example, a photograph may be taken of the bottom surface of the foot and a 2D projection or profile of the bottom of the foot may be derived from the photograph. Each foot shape record in the database may comprise a 2D projection of the bottom of the foot and full 3D data (e.g. a point cloud) describing the 3D shape of the foot. By comparing the 2D projections, a foot of similar shape can be found in the database. The full 3D data for that foot can then be accessed, on the assumption that if the 2D projections are similar the whole foot shape will be similar. While a 2D projection of the bottom of the foot is mentioned as an example above, it is possible to use 2D projections of other surfaces of the foot instead or as well.

As a perfect match may not be found, any foot shape projection that differs by less than a pre-set threshold may be accepted. Furthermore, several foot shapes having similar 2D profiles may be selected and an average taken to generate a unique approximate foot shape for the photographed foot. All foot shapes having 2D profiles within a certain tolerance range may be selected and a weighted or non-weighted average 3D foot shape generated.

The 2D projections in the database may be generated by applying projection equations to the full 3D data for each foot. The 2D projections are preferably generated when the database is first set-up.

A convenient way of comparing 2D projections is to compare the turning function of the projections. Each 2D projection will have a turning function, e.g. a turning function as described in Esther M. Arkin, L. Paul Chew, Daniel P. Huttenlocher, Klara Kedem, Joseph S. B. Mitchell, (1991) An Efficiently Computable Metric for Comparing Polygonal Shapes, IEEE Transactions on Pattern Analysis and Machine Intelligence, v. 13 n. 3, p. 209-216; however other suitable turning functions may be apparent to a person skilled in the art. Turning functions are a convenient and efficient way of comparing 2D shapes.

Other methods of comparing foot shapes may be used and will apparent to those skilled in the art, they include but are not limited to, Principal Component Analysis (comparing the angles of the Principal Component of two profiles), Lp (or Euclidean) Distance (Point-to-point distance), Hausdorff Distance and Frechet Distance (variations of Lp Distance) Area of Symmetric Difference etc.

The 2D projection of the bottom of the foot does not give enough information to describe a foot completely. For example, it does not describe the height of the foot, or height variations in the medial or plantar surfaces. Therefore, in order to get a better match to the foot being photographed, other data and 2D projections of other surfaces may be taken into account and included in the foot shape signature. For example 2D projections of the side of the foot may be compared in the same way as described above for the bottom surface. In a preferred embodiment the height to length ratio of the arch of the foot is considered. In combination with the one or more 2D profiles, the foot arch height to length ratio gives a good representation of the foot.

The foot arch height to length ratio may be found from the photographs, either automatically by computer or manually. Alternatively the length and height of the arch could be measured manually and entered into the system.

Preferably the foot shape signature comprises data based on a 2D projection of the bottom of the foot and the foot arch height to length ratio. In one embodiment the 2D projection of the bottom of the photographed foot is compared with 2D projections in the database and foot shapes having similar 2D projections are selected in a first stage. The foot arch height to length ratio of the photographed foot is then compared with the ratios of the selected feet and the most similar ones selected in a second stage. Other orders or methods of comparison are possible and will be apparent to a person skilled in the art.

One factor, which may limit the accuracy of the foot shape matching, is perspective distortion. Therefore, it is preferred that the 2D projections of the photographed foot and any stored dimensions are adjusted to correct for perspective distortion. Various techniques for correcting perspective distortion are discussed below.

Preferably some or all of the 2D projections of the foot are corrected for perspective distortion. That is some or all of their dimensions are adjusted in order to reduce or eliminate perspective distortion. In addition certain discrete measurements of foot dimensions may be adjusted also. For example, any or all of the maximum length of the foot, maximum width of the foot, height of certain parts of the foot, height of the foot arch and length of the foot arch may be derived from the photographs or 2D projections and then corrected for perspective distortion in accordance with predetermined equations.

The maximum width of the foot is not at the bottom of the foot, but is usually just above the ball joint (or more accurately the 1^{st} and 5^{th} Metatarsophalangeal joint). Therefore a photograph of the front of the foot can be used to find the foot's maximum width. In one embodiment this is done by finding the height of the ball joint from a photograph of the front of the foot, finding the apparent width of the foot from a photograph taken from the bottom of the foot and adjusting the apparent width to compensate for perspective distortion. The compensation for perspective distortion involves an equation which utilizes the height of the maximum width as one variable.

Once the 3D foot shape has been generated from the one or more selected foot shapes in the database, it is preferably re-scaled to fit the size of the actual foot. The generated foot shape will have the same ‘normalized’ size as the foot shapes in the database. This re-scaling may be done by reversing the scaling carried out previously, or by re-adjusting the 3D foot shape to fit the (original un-scaled) 2D projections of the foot. This may be done using standard 3D scaling techniques. In one embodiment the scaling is carried out on the basis of measurements of the maximum width and length of the foot. The scaling preferably also takes account of measurements of the foot height. As the foot dimensions varies along its length (width and height), the foot may be conveniently split along its length (width or height) into a plurality of sections and the dimensions adjusted separately for each section. For example, the 3D foot shape may be sectioned into a plurality (e.g. several hundred) sections along the x-axis. The coordinates of each point in a section may then be multiplied by an appropriate factor so that the dimensions of that section match with the 2D projections of the foot.

It is desirable to have real foot dimensions in the 3D model. Therefore it is preferable to convert the pixel data in the photographs to real dimensions (e.g. pixels per mm). This may be achieved by photographing an object having known dimensions and working out a pixel to real length (e.g. mm) scale accordingly. The object may be a purpose made scale calibration device, e.g. a scale calibration jig having a plurality of calibration markings thereon. Preferably the scale calibration device enables the distance of the device from the camera as well as the pixel to real length scale to be calculated automatically by a computer.

A second aspect of the present invention provides an apparatus for generating a 3D foot shape comprising;—

at least one camera,

a base for supporting a foot

a computer program for extracting foot shape data from the photograph

a computer program for comparing the extracted foot shape data with a plurality of foot shape data of different foot shapes stored in a database and selecting one or more of said foot shapes which have similar foot shape data to the photographed foot; and

a computer program for generating a 3D foot shape of the photographed foot on the basis of the one or more selected foot shapes.

The terms “computer” and “computer program” are intended to cover any type of hardware, software or combination therefore configured for performing the above functions. They may be programs for running on a computer, modules of such computer programs, custom-made integrated chips, programmable integrated chips etc. Other possibilities may be apparent to a person skilled in the art.

The one or more cameras may be any kind of image sensory devices, preferably digital, including compact cameras and single-lens reflex cameras. In a preferred embodiment a single unit provides a base for supporting the foot and the cameras. The image sensory planes of the one or more cameras are preferably perpendicular to the base.

The cameras may be supported by a camera station. Preferably the alignment of each camera is adjustable.

Preferably the apparatus is arranged to take photographs of at least the bottom of foot and preferably also one or both sides of the foot and the front of the foot. This may be carried out by a single camera, which is movable or has a suitable optical arrangement for taking photographs of different parts of the foot. More preferably the apparatus comprises a plurality of cameras, one each for taking photographs of the bottom, left side, right side and/or front of the foot. In a preferred embodiment the cameras are provided opposite the base for supporting the foot. Light may be directed to the respective cameras by an optical arrangement, e.g. one or more mirrors for directing light from a particular surface of the foot to an appropriate respective camera. Such mirrors are not essential, however they do enable some or all of the cameras to be conveniently placed side by side at the same location, rather than in different locations relative to the foot.

The database may be stored in the apparatus. Alternatively the database may be separate from the apparatus, but accessible remotely, e.g. over a computer network.

The base may have one or more alignment markings for facilitating alignment of an object on the base with a camera—e.g. for aligning a foot or calibration jig placed on the base with a camera.

The apparatus is arranged to carry out the method according to the first aspect of the present invention and may incorporate any of the features of the first aspect of the invention discussed above. For example, the 3D foot shapes are preferably 3D point clouds. The foot shapes in the database are preferably all aligned with a common axis. The foot shapes in the database are preferably all scaled to a predetermined size. The foot shape data derived from the photographs is preferably scaled to the same scale as the foot shapes in the database.

Preferably the foot shape data is a ‘foot shape signature’. A foot shape signature is data describing the shape of the foot and preferably comprises one or more values or functions describing the shape and/or other characteristics of the foot. The foot shape signature is preferably based on one or more 2D projections of the foot.

The apparatus may be arranged to derive a 2D projection or profile of the bottom of the foot and/or a side of the foot from the one or more photographs. Each foot shape record in the database may comprise a 2D projection of the foot and full 3D data (e.g. a point cloud) describing the 3D shape of the foot.

The apparatus may be arranged to select any foot shapes having a 2D projection that differs by less than a pre-set threshold from the 2D projection of the photographed foot. The apparatus may be arranged to select several foot shapes having similar 2D profiles to generate an average 3D foot shape from said selected foot shapes. The apparatus may be arranged to compare the 2D profiles by comparing their turning functions.

The foot shape signature may comprise a 2D projection of the foot and a height to length ratio of the arch of the foot. The apparatus may be arranged to compare said 2D projection and said ratio to the 2D projections and ratios of feet shapes in the database.

The apparatus may be arranged to correct the one or more 2D projections and or dimension measurements of the foot for perspective distortion.

The apparatus preferably is arranged to scale the generated 3D shape for the foot to match the one or more 2D projections or other dimension measurements of the photographed foot.

A third aspect of the present invention provides a method of generating a 3D foot shape comprising the steps of:—

calibrating a camera using a perspective calibration device;

using the camera to take one or more photographs of a foot;

adjusting the photograph, or data derived from the photograph, to compensate for perspective distortion;

and generating the 3D foot shape from data derived from the photograph.

As the photographs, or data (such as 2D projections or dimension measurements) derived from the one or more photographs is adjusted to compensate for perspective distortion, the generated 3D foot shape is more accurate.

Preferably the 3D foot shape is in the form of 3D point cloud data, but other 3D representations could be used.

Preferably the calibration step comprises photographing the calibration device and comparing a photograph of the calibration device to known features of the calibration device. The calibration device may be placed at a known location and orientation (e.g. along an axis of the apparatus) relative to the camera, however the calibration device may be of a type that can be used even if its distance from the camera is not known beforehand.

Preferably the calibration device comprises a pair of predetermined images on parallel planes a predetermined distance apart from each other. The photographs of the two images may be compared and used to calculate an appropriate perspective distortion correction. For example information from photographs of the two images may be used to calculate a conversion factor for predetermined perspective correction equations.

The perspective calibration device preferably also enables the 3D model of the foot to be rendered in real dimensions (e.g. mm) by allowing the camera to calibrate a pixel to length conversion. E.g. if a calibration marking has a known length of 5 mm and is 10 pixels in length in the photograph then the conversion would be two pixels to each millimeter. The calibration device may also enable the distance between the camera and the calibration device to be automatically calculated.

The method of the third aspect of the present invention may be combined with the method of the first aspect of the present invention.

A fourth aspect of the present invention provides an apparatus for generating a 3D foot shape, the apparatus comprising:—

a camera for taking one or more photographs of a foot;

a perspective calibration device for obtaining calibration data;

a perspective correction module programmed to adjust the one or more photographs, or data derived from the one or more photographs, to compensate for perspective distortion;

and a module for generating the 3D foot shape from data derived from the photograph.

Preferably the 3D foot shape is in the form of 3D point cloud data.

Preferably, when in use, the calibration device is positioned at a known orientation (e.g. along an axis marked on the apparatus). The apparatus may comprise a base for supporting a foot and said base may have one or more calibration markings for aligning the foot with the camera and/or aligning the calibration device.

Preferably the perspective correction module is arranged to compare a photograph of the calibration device with known features of the calibration device and to correct for perspective distortion based upon said comparison.

The calibration device may comprise a pair of predetermined images on parallel planes a predetermined distance apart from each other. The perspective correction module may be arranged to compare photographs of the two images and to calculate an appropriate perspective distortion correction based on said comparison. For example the module may be arranged to use information from photographs of the two images to calculate a conversion factor for predetermined perspective correction equations.

The apparatus of the fourth aspect of the present invention may be combined with the apparatus of the second aspect of the present invention.

A fifth aspect of the present invention provides a database of foot data comprising a plurality of records, each record comprising a 3D model of the foot and a shape signature for the foot; wherein the shape signature comprises one or more dimensions of the foot and/or one or more values or functions describing the shape of a 2D projection of the foot. The 3D model may take the form of a 3D point cloud.

Preferably the shape signature further comprises a foot arch length to height ratio for the foot. Preferably the 3D model for each foot is aligned to a common axis. Preferably said 3D models are scaled to a predetermined size.

The apparatus of the fifth aspect of the present invention may be used in any of the above described methods and apparatus according to the first to fourth aspects of the present invention.

A sixth aspect of the present invention provides a method of forming a database of foot data comprising the steps of inputting 3D models for a plurality of feet, for each foot generating at least one 2D projection of the foot based on the 3D model, and generating a record for each foot, the record comprising the 3D model and a shape signature based on the 2D projection.

Preferably the method comprises the step of aligning each 3D foot model to a common axis. Preferably the shape signature comprises a value or function based describing the shape of the foot, e.g. a turning function of the 2D projection. Preferably the method comprises storing the records on a storage medium.

A seventh aspect of the present invention provides an apparatus for obtaining the shape of a foot inside a shoe, comprising a seamless molded sock made from a single piece of elastic material.

Preferably said elastic material is a non-allergenic material, e.g. a silicone rubber.

The apparatus is useful because it enables the wearer to simulate their foot shape when inside a shoe. The apparatus is elastic and so adjusts to the size of the foot and applies a compressive pressure, e.g. to press the toes together, so that the foot adopts a similar shape to if it was inside the shoe. Furthermore it has a strong enough elastic force that it can cause the foot to adopt a different posture, rather than just adapting passively to the existing shape and posture of the foot. This is an improvement to simply scanning or measuring a bare foot on a base, as a bare foot will assume a different shape and position compared to if it was inside a shoe.

Furthermore, as the apparatus is seamless, it may be scanned or photographed without the seams distorting the image, affecting the posture of the foot or the perceived fit.

Although the apparatus adjusts to the size of the foot, feet have a large variation in sizes; therefore a plurality of different sized apparatus may be available so that the one with the best fit for the foot and best approximation to the type of shoe being simulated may be chosen.

The apparatus of the seventh aspect of the present invention may be used with any of the methods or apparatus of the first to sixth aspects of the present invention. However, it is not limited thereto and may be used with other apparatus or methods for measuring or digitizing a foot.

An eight aspect of the present invention provides method of measuring a foot comprising placing the foot in the apparatus of the seventh aspect of the present invention and then scanning or photographing the foot using an optical device. Measurements or a 2D or 3D model of the foot may be derived from the data collected by the optical device.

The method of the eighth aspect of the present invention may be used with any of the methods or apparatus of the first to sixth aspects of the present invention.

Unless the context demands otherwise any of the above aspects of the present invention may be combined with each other and any of the features of one aspect may be applied to another aspect.

A ninth aspect of the present invention provides an apparatus for making the apparatus of the seventh aspect of the present invention. The apparatus comprising a mold approximately in the shape of a foot and around which molding material may be deposited in order to form the sock-like apparatus. Preferably the mould is rotatable about a base.

A tenth aspect of the present invention provides a method for making the apparatus of the seventh aspect of the present invention comprising the step of dip molding the mold of the ninth aspect of the present invention into a molding material and allowing the material to form and set around the mold and then removing the material from the mold. The molding material may be liquid silicone rubber. A curing agent and/or heating may be applied to the material to cause it to set. The mold may be rotated to aid with the curing process and/or to ensure that the material is substantially evenly distributed around the mould.

An eleventh aspect of the invention provides a method of generating a 3D foot shape comprising the steps of:—

taking one or more photographs of the foot,

deriving one or more foot dimensions and/or 2D projections from the one or more photographs,

and generating a 3D foot shape for the photographed foot based on a stored 3D model of a foot and resizing the stored 3D model to fit said one or more dimensions and/or 2D projections derived from the one or more photographs.

A twelfth aspect of the invention provides an apparatus for generating a 3D foot shape comprising:—

one or more cameras for taking one or more photographs of the foot,

a computer program for deriving one or more foot dimensions and/or 2D projections from the one or more photographs,

a computer program for generating a 3D foot shape for the photographed foot based on a stored 3D model of a foot and resizing the stored 3D model to fit said one or more dimensions and/or 2D projections derived from the one or more photographs.

The stored 3D model of the foot may be in 3D point cloud format. Typically it is a model of another foot selected from a database of different foot shapes. Alternatively the stored 3D model may be a single default foot shape used for all feet and which is resized and re-shaped to fit the 2D projections or dimensions of the foot. In both cases the 3D model may have originally been derived by any appropriate means, e.g. by laser scanning a real foot. Preferably the 3D model is resized and/or reshaped to fit the 2D projections, as this allows greater accuracy than relying on single dimensions (width, height, length etc) alone. In this way the available data from the 2D projections is supplemented by ‘surface data’ and other details from the 3D model, to arrive at a reasonable approximation of the 3D shape of the photographed foot.

The eleventh and twelfth aspects of the present invention may use any of the features of the first to tenth aspects of the invention discussed above.

In physical terms the system may generally have three parts: the supporting platform, the camera station and the computer unit. The system may also be accessorized with a set of calibration jigs which are used for camera calibration. The person stands on the platform and the foot is aligned with the alignment axes marked on the platform. In one embodiment there are three mirrors around the platform to reflect the side views and the plantar view of the foot to the camera station.

The cameras may be connected to the computer unit using the USB protocol. The viewfinder image is transmitted to the computer unit and displayed in the monitor. The cameras can be precisely calibrated with the help of the calibration jigs. From the computer screen the user is able to calibrate each camera and adjust the camera parameters such as the lens focal length, focus and the photo exposure.

After the foot is aligned on the standing platform, the cameras will preferably start capturing (photographing) the images of the projections simultaneously. In one preferred embodiment each camera is dedicated to a respective projection of the foot. This capturing process usually takes less than one second, depending on the luminosity of the surrounding environment. However, it would be possible for a single camera to capture the images required for all the projections, e.g. by moving the camera or by an arrangement of mirrors to reflect light from different surfaces of the foot to the same camera.

### BRIEF DESCRIPTION OF THE DRAWINGS

FIG. 1 is a perspective view of the foot shape generation system.

FIG. 2 is a perspective view of the support platform.

FIG. 3 is a perspective view of the standing plate.

FIG. 4 is a perspective view of the back of the camera station and computer unit.

FIG. 5 is a perspective view of the front of the camera station and computer unit.

FIG. 6 is a perspective view of the front of the camera station with the upper part removed.

FIG. 7 is a perspective view of the back of the camera station with the upper part removed.

FIG. 8 is an assembly drawing of the camera holding knob.

FIG. 9 is a perspective view illustration of the alignment of cameras.

FIG. 10 is a top view illustration of the rays of the left camera.

FIG. 11 is a top view illustration of the rays of the front camera.

FIG. 12 is a side view illustration of the rays of the bottom camera.

FIG. 13 is a perspective view of the alignment jig.

FIG. 14 is a perspective view of the scaling jig.

FIG. 15 is a block diagram of the foot shape generation process.

FIG. 16 is a block diagram of the camera calibration.

FIG. 17 is a block diagram of the database building process.

FIGS. 18(a) and 18(b) illustrate the principle of perspective distortion;

FIG. 19 shows a system for correcting perspective distortion at the side of the foot;

FIG. 20 shows the foot profiles for the bottom of two different feet;

FIG. 21 shows the turning functions for the foot profiles of FIG. 20;

FIG. 22 illustrates sectioning of the foot into different sections for scaling on the z-axis;

FIG. 23 shows sectioning of the foot into different sections for scaling on the x and y axes;

FIG. 24 is a perspective view of an aluminum mold for making an ISSI.

FIG. 25 is a lateral view of the aluminum mold in FIG. 25.

FIG. 26 is a top view of the aluminum mold in FIG. 25.

FIG. 27 is a perspective view of the ISSI made from the aluminum mold in FIG. 25.

### DETAILED DESCRIPTION OF PREFERRED EMBODIMENT

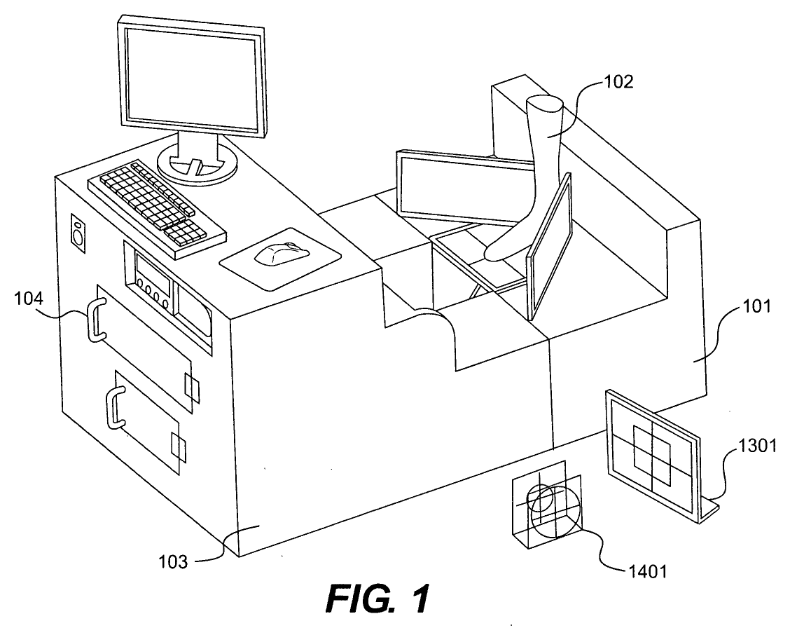

FIG. 1 illustrates one embodiment of the present invention. It shows a base or standing station 1001 for supporting the foot 102, a camera station 103 at which cameras are located, and a computer unit 104 for measuring foot dimensions and generating the foot shape in 3D format, preferably 3D point cloud format.

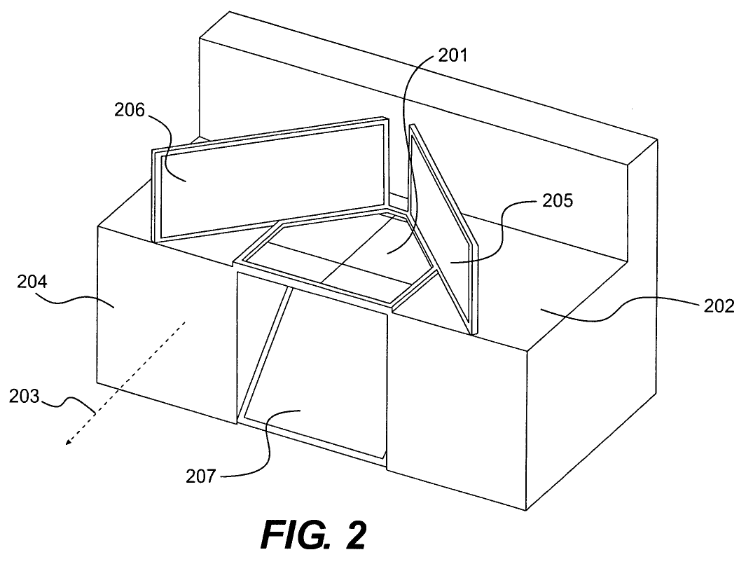

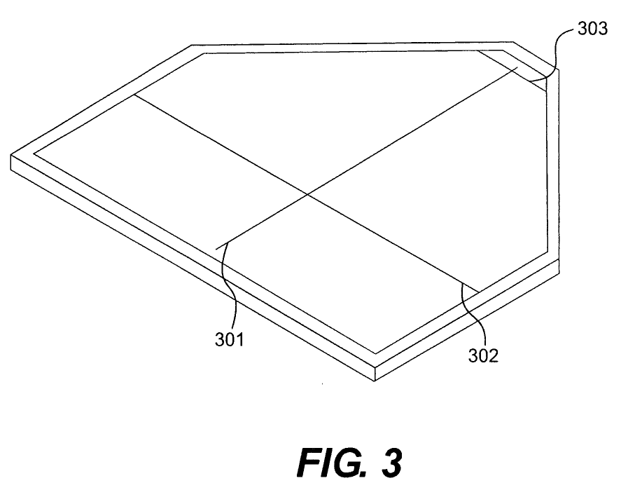

FIG. 2 shows the detailed design of the base or standing station 101. The standing station or base 1001 includes a non-opaque standing plate 201 which can support full body weight of the subject. The detailed design of the standing plate is shown in FIG. 3. As can be seen in FIG. 3, the standing station 101 has a plurality of alignment markings 301, 302, 303. In this embodiment the alignment markings take the form of lines or axes. One of the subject's feet is aligned with the foot length axis 301 when standing on the standing plate 201 while the other foot is on the supporting platform 202. The foot length axis 301 is marked on the center of the standing plate 201 for foot alignment and is parallel to the normal 203 of the contact plate 204. The heel-edge line 303 is perpendicular to the foot length axis 301 such that the person of the foot 102 can reference the intersection point of heel-edge line 303 and foot length axis 301. The line 302 is for camera orientation calibration. The camera orientation calibration is herein described. The line width of the alignment axes 301, 302 and 303 should be thin enough, e.g. 0.5 mm, so that it will not cause interference with the images captured by bottom camera 601. There are two mirrors for reflecting images of the foot to the cameras. The left side mirror 206 and right side mirror 205 are located aside from the standing plate 201 such that they reflect the lateral and medial side images of the foot 102. Both the left side mirror 206 and right side mirror 205 are fixed at an angle of 45 degrees to the foot length axis 301. The bottom mirror 207 under the standing plate 201 gives the plantar view of the foot. The bottom mirror 207 is fixed at an angle of 45 degrees to the standing plate 201.

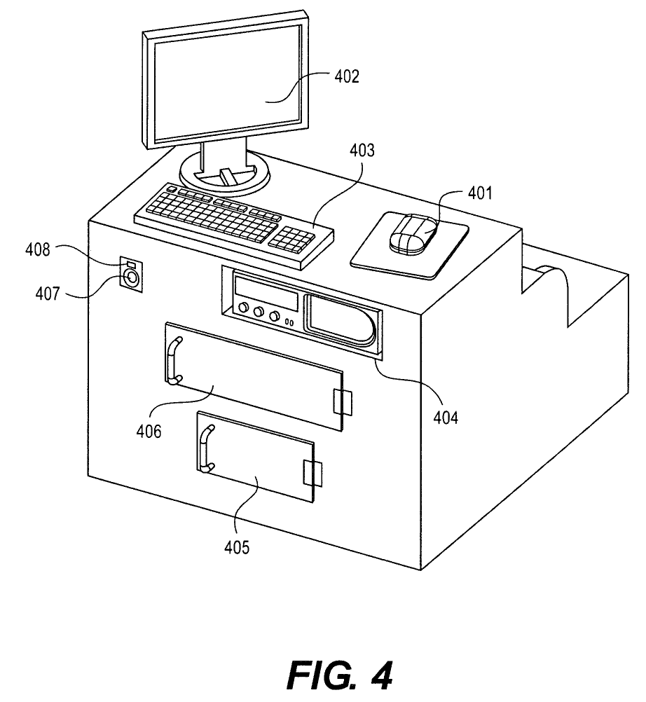

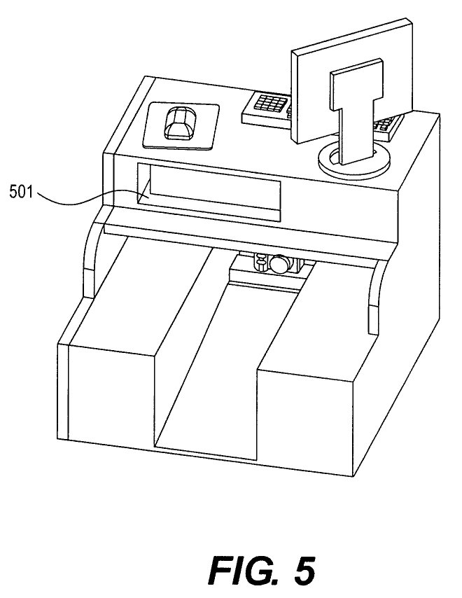

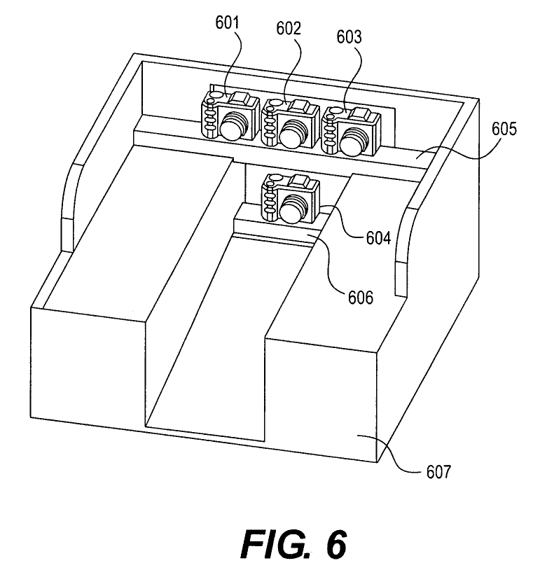

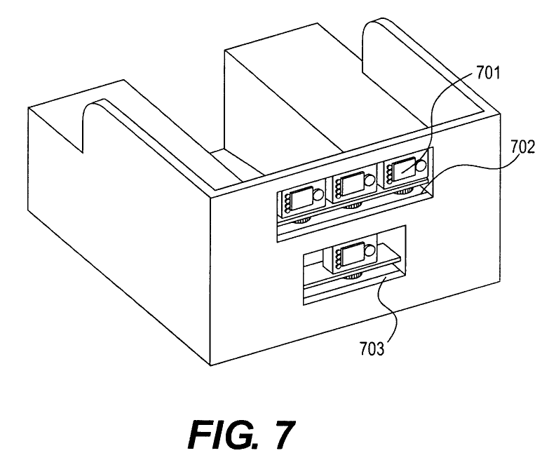

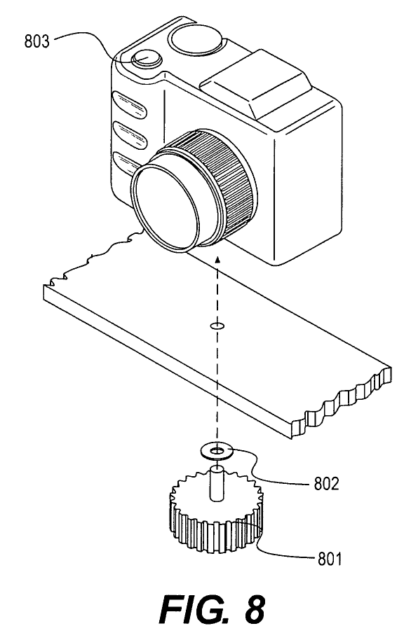

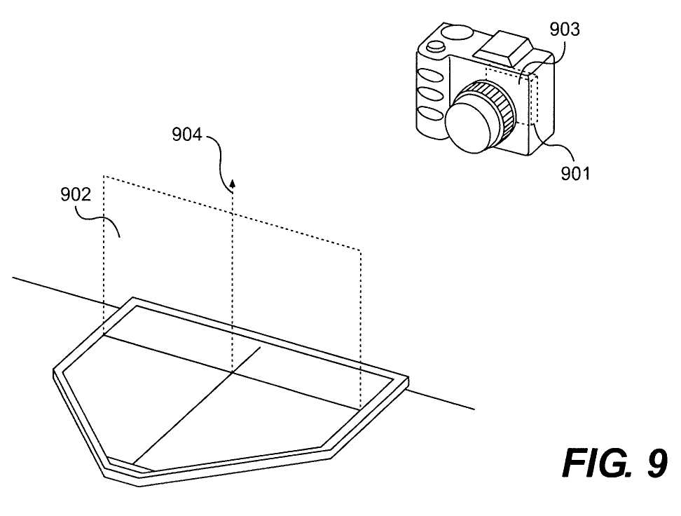

FIG. 4 is the front view of the camera station 103. FIG. 5 is the back view of the camera station 103. At the top of the camera station 103 a display (e.g. monitor 402) and one or more input devices (e.g. keyboard 403 and mouse 401) of the computer unit 104 are placed. The computer unit 104 is in the middle of the camera station 13. The user is able to operate the computer unit 104 using the keyboard 403, mouse 401 and monitor 402. User can also control the computer unit 104 through the front window 404. The rear window 501 is designed for the computer unit 104 diagnostics and maintenance. The main power switch 407 of the system is located next to the front window. An indicator, such as a red LED 408, will light when the system is turned on. In the lower part of the camera station 103, there are supports, e.g. supporting bars 605 and 606, to support the cameras. The base of the camera station 103 is channel, preferably a U-shaped channel, such that the bottom camera 606 can capture the image from the bottom mirror 207. FIG. 6 and FIG. 7 show the lower part of the camera station 103. Cameras 601, 602, 603 and 604 are located inside the camera station. Users can adjust the camera settings through the two windows 702 and 703. Under each camera, there is a direction adjusting device, e.g. knob 801 and a spring washer 802, assembled to enable the user to adjust the direction of each camera, as shown in FIG. 8. The camera direction should be fine tuned before use such that the image plane 903 is parallel to the alignment plane 902. The alignment plane 902 is a virtual plane. It is defined by the calibration axis 302 and the normal 904 of the standing plate 201, as shown in FIG. 9. The camera direction calibration will be described further herein. Covering doors 406 and 405 provide protection to cameras against accidental movements.

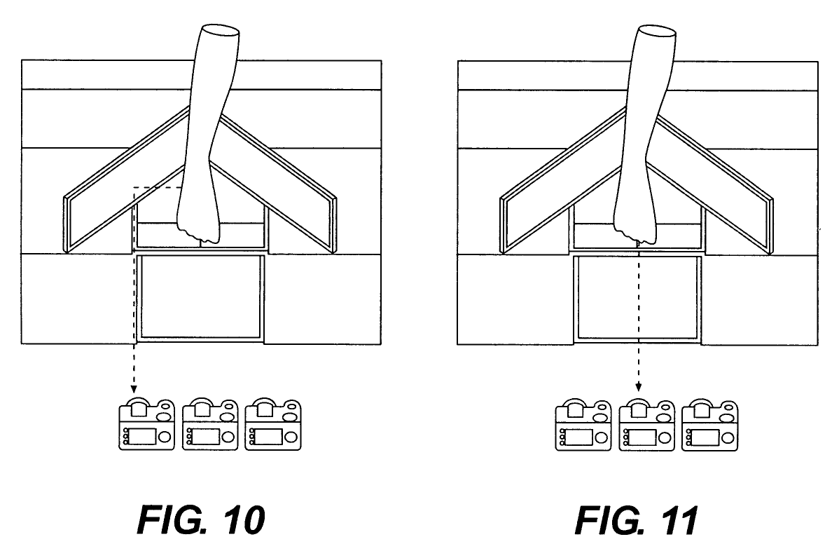

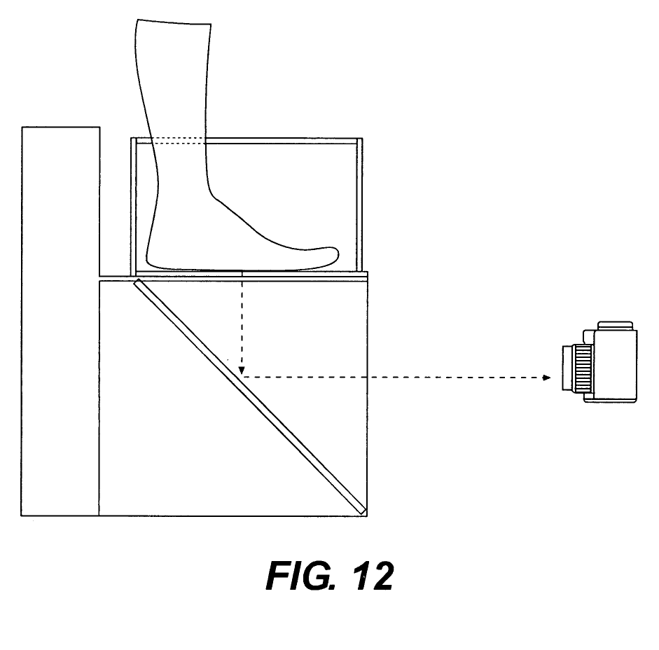

The left camera 603 and the right camera 601 can photograph side view images of the foot 102 formed from the left side mirror 206 and the right side mirror 205. Referring to FIG. 10, the rays from the side image of the foot 102 fall on the left side mirror 206 and is reflected towards the left camera 603 by the left side mirror 206. Through the computer monitor 402 or the camera LCD screen 701, the user is able to watch the live image that is being captured by the image sensor 901. Once camera shutter 803 is fired, the left camera 603 photographs the left side view image of the foot 102 and transmits the image to the computer unit 104. The right camera 601 uses the similar method to photograph the image of another side of the foot 102. Front camera 602 photographs the image of the front view of the foot 102 directly without mirror reflection while the bottom camera 604 photographs the plantar view from the bottom mirror 207. The method used by bottom camera 604 is also similar as the left camera 603. The ray paths for the left camera 603, front camera 602 and bottom camera 604 are illustrated in FIGS. 10, 11 and 12 respectively.

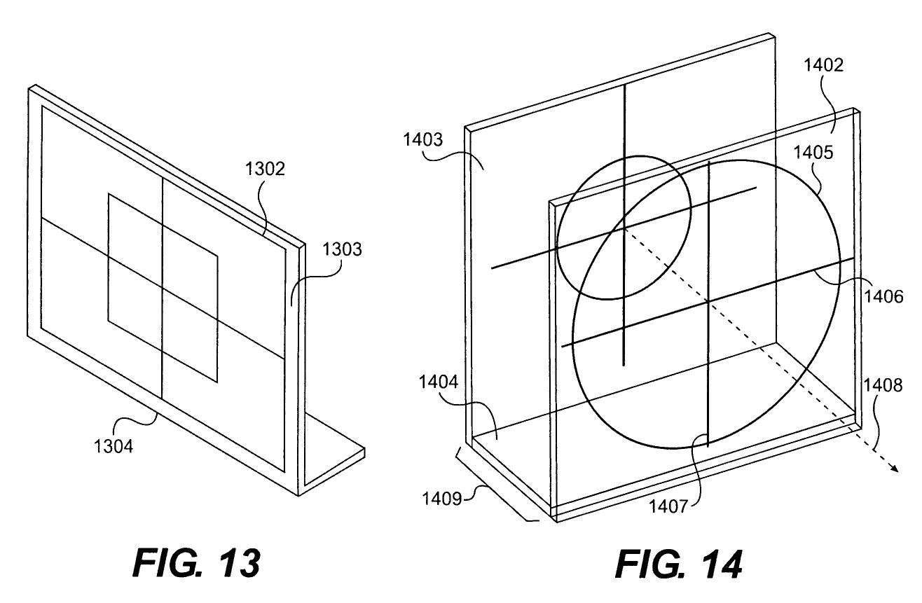

As shown in FIG. 13, an alignment device (e.g. alignment jig 1301) is designed to assist the camera direction calibration. The alignment jig 1301 can be made of any suitable material, e.g. plastic. Alignment pattern 1302 is marked on the front surface 1303 of the alignment jig 1301. The alignment pattern 1302 preferably includes several regular 2D shape patterns as shown in FIG. 13. For calibration of the left camera 603 and right camera 601, the alignment pattern 1302 should be placed on the standing plate 201 facing the left side mirror 206 and the right side mirror 205 respectively. The front contact edge 1304 should be aligned with the foot length axis 301. For calibration of the front camera 604, the front contact edge 1304 should be aligned so that the camera calibration axis 302 with alignment pattern 1302 facing the front camera 602. For the calibration of bottom camera 604, the alignment pattern 1302 should be touching the top surface of the standing plate 201 and facing the bottom mirror 207. All the cameras should be able to clearly capture the image of the alignment pattern 1302 during the calibration process, and the computer unit 104 is able to display the live view of the image captured by the cameras in the monitor 402. The detailed procedure of camera direction calibration will be described further herein.

FIG. 14 shows the detailed design of the perspective calibration and scaling device (e.g. scaling jig 1401), which is used for camera scaling calibration and perspective distortion calibration. The scaling jig 1401 is made of 3 plates: The front plate 1402, rear plate 1403 and base plate 1404. The front plate 1402 is transparent while the rear plate 1403 and base plate 1404 are opaque. The front and rear plates 1402, 1403 are parallel planes and separated from each other by a known distance. Scale patterns are marked on the inward surface of front plate 1402 and outward surface of the rear plate 1403. The scale pattern on the front plate 1402 preferably includes a circle 1405 centered at the center of the plate in which it is marked, with a specified diameter such as 80 mm, a horizontal line 1406 and a vertical line 1407. The lines intersect at the center of the circle 1405. The scale pattern on the rear plate 1403 is preferably same as the scale pattern on the front plate 1402 except that the diameter of circle is half of that on the front plate 1403. The centers of the circles on front plate 1402 and rear plate 1403 lie on the normal 1408 of the front plate 1402. The distance between the two circle centers is determined by the width 1409 of the base plate 1404. The detailed steps of camera calibration will be described further herein.

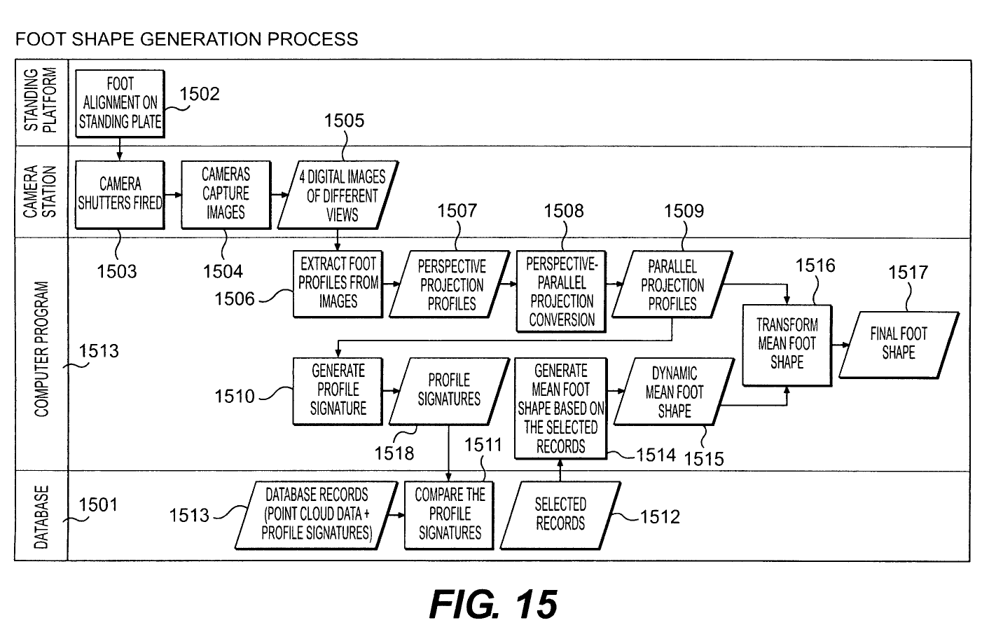

Referring to FIG. 15, a flow diagram of the foot shape generation process is shown. In the supporting platform 101, the foot 102 is aligned on the standing plate 201 (1502). When the shutters 803 of the cameras in the camera station 103 are fired (1503), either manually or by electronic means from the computer unit 104, the cameras start capturing (photographing) the images of lateral side, medial side, front and bottom views of the foot 102 (1504). The image data 1505 is transmitted to the computer units 104, e.g. through cables or wireless network or flash memories. The image data 1505 is then be loaded onto a computer program 1513 installed in the computer unit 104.

The computer program (1513) extracts 2D profiles 1507 of the foot 102 from the photographed images (1506). The profiles 1507 obtained from the photos are based on 2D perspective projections. Various methods may be used to extract the profiles from the photographs; in one method the photographs are converted to grey scale, the foot is extracted and other parts of the image discarded and the outline of the foot is obtained as the 2D perspective projection. To enhance accuracy, the 2D perspective projection is preferably converted to a parallel projection as explained below.

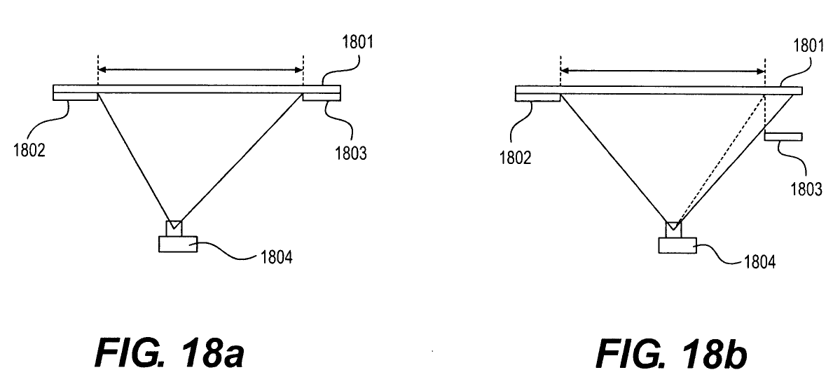

When a 3D object is projected into a 2D plane (such as a 2D image), the image is called a “perspective projection”. The projection adds a certain error on to the measurement, called Linear Perspective Distortion. This is illustrated in FIG. 18 (a) and FIG. 18 (b) which show how an object appears larger when it is closer to the camera. In the figures, the object 1801 is a ruler. Two tabs 1802 and 1803 are placed on the ruler. In FIG. 18(b) one of the tabs is moved closer to the camera 1804. Although the lateral distance between the tabs 1802 and 1803 is the same in FIGS. 18 (a) and 18 (b), the distance appears larger in FIG. 18 (b) because the tab 1803 is closer to the camera. The apparent distance detected by the camera is shown by the solid lines, the actual distance by the broken lines. In FIG. 18 (a) it is 10.3 cm, while in FIG. 18 (b) it is 10.6 cm (these measurements are by way of example only).

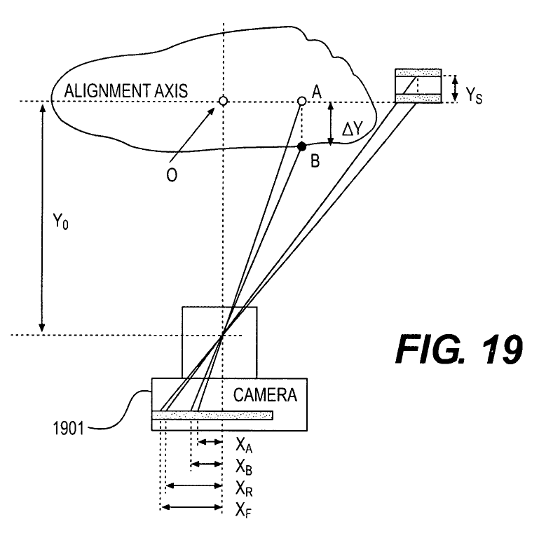

A parallel projection is a projection that has no linear perspective projection. If the distances between the object and the camera are known, then a perspective projection can be transformed into a parallel projection free of perspective distortion. FIG. 19 illustrates the perspective correction for a side view of the foot. Two points on the front plane F and rear plane R of the perspective adjustment jig are shown. The apparent positions of these points as viewed by the camera 1901 are XF and XR. A point B is shown on the periphery of the foot, which corresponds to a nominal point A on the axis of the foot.

The calculation for perspective correction is

$$\begin{matrix}{X}_{A} = {X}_{B} [ 1 + ( \frac{Δ Y}{{Y}_{0}} ) ] \\ = {X}_{B} [ 1 + Δ Y ( \frac{{X}_{R} - {X}_{F}}{{X}_{R} \times {Y}_{s}} ) ]\end{matrix}$$

Where X_{A} is the “correct measurement” (parallel projection) and X_{B}, is the “distorted measurement” (perspective projection). This is the calculation for the side view, other views have slightly different calculations but according to the same principle. The computer program 1513 converts the perspective projection 1507 to parallel projection 1509 based on the result from camera calibration (1508) described above.

A pattern signature 1518 for each profile or projection 1509 is generated (1510). The signature preferably includes data representing a profile (e.g. bottom profile) of the foot and data describing the arch of the foot. In this embodiment the data representing the arch of the foot is the ratio of the height of the arch to the length of the arch. This may be extracted from the photographs or a 2D projection of a side of the foot either manually or automatically by computer. Points indicating the height and length of the arch may be marked on the person's foot by pen or other marker to enable them to be easily identified in the photographs, however this is not necessary.

The 2D profile of the bottom of the foot may be conveniently represented by a turning function. Turning functions provide a simple and efficient way of comparing 2D profiles. An example of a suitable turning function is discussed in Esther M. Arkin, L. Paul Chew, Daniel P. Huttenlocher, Klara Kedem, Joseph S. B. Mitchell, (1991) An Efficiently Computable Metric for Comparing Polygonal Shapes, IEEE Transactions on Pattern Analysis and Machine Intelligence, v. 13 n. 3, p. 209-216. Turning functions measure the change in curvature around the profile and are useful as they are a representation of the shape of the foot which is robust against translation, scaling and translation.

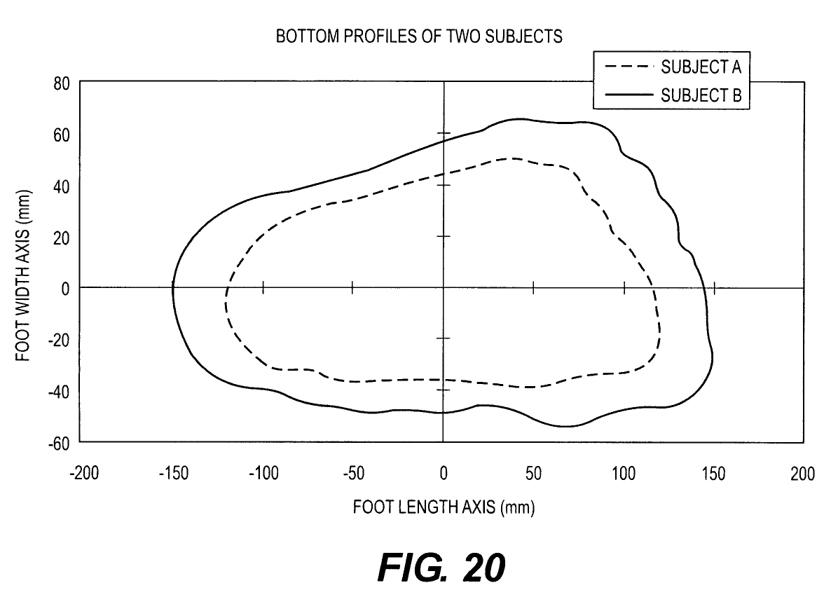

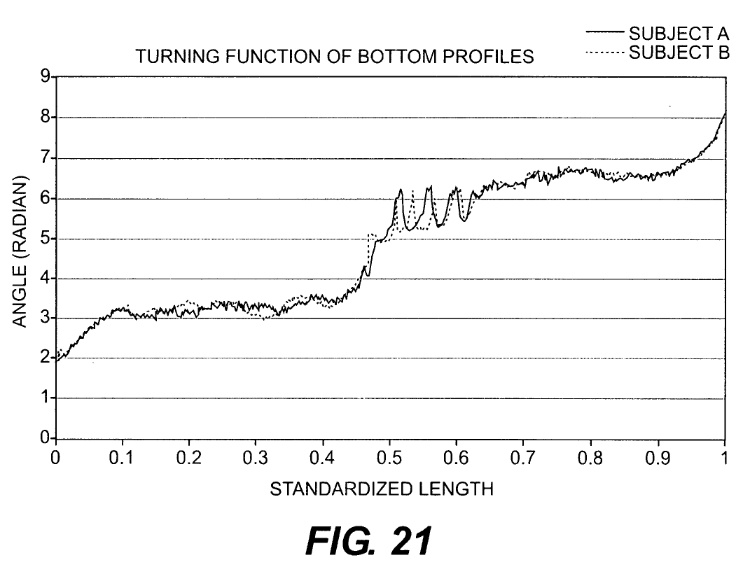

FIG. 20 shows the 2D profiles of the bottom of two different feet, while FIG. 21 shows a comparison of their turning functions. In general the less the difference between the turning functions the more similar the shape of the two profiles being compared.

Turning functions are automatically normalized with the circumference of the shapes they are derived from. Therefore it is not necessary to scale the 2D projections or turning functions of the photographed foot. Instead the turning function can be compared directly with the turning functions in the database. For other types of function it may, in some cases, be necessary to scale the 2D projections and a person skilled in the art will know when this is necessary and be able to write a program to carry out the scaling accordingly.

The signature 1518 of the photography foot will be sent to a database 1501 to perform signature comparison (1511) with foot signatures in the database. The database 1501 can be part of the built-in computer unit 104 which enables it to run as a standalone system, or it can be located on a separate computer if it is to be implemented a distributed system. The database 1501 will perform a search in all the records that it holds (1511), and return the list of records 1512 in ascending order of similarity. The number of records returned is specified by the user selection criteria. For example the user may specify to return a certain number or records, or all records having similarity within a specified threshold. In one embodiment the turning functions of the 2D profiles of the bottom of the foot are compared in a first stage and the foot arch height to length ratio is compared in a second stage. Each record 1513 in the database 1501 includes a complete set of foot shape point cloud data and a signature including the side view profile (or just the arch height to length ratio) and the bottom view profile (or its turning function). The process of building the database will be described later. While the bottom view profile is mentioned above and is preferred, It would be possible to raise other profiles interested.

The computer program 1513 retrieves the ordered records from database 1501 and generates a real-time mean foot shape 3D point cloud (1514). This ‘real-time mean foot shape’ is an average of the foot shapes stored in the selected records. It may be a weighted average or a simple average with each record given equal weight. By generating an average foot shape from the most similar records, a very good approximation of the measured foot may be generated.

Preferably the database has a plurality of records, each having a different foot shape and a related foot shape signature. In some preferred embodiments the database has 10, 20, 50, 100 or even 200 or more records. Having a plurality of records of different foot shapes helps to enhance the accuracy. However, it would be possible to have a database with only one record (i.e. for a single ‘standard’ foot shape). In that case the single ‘standard’ foot shape is always used.

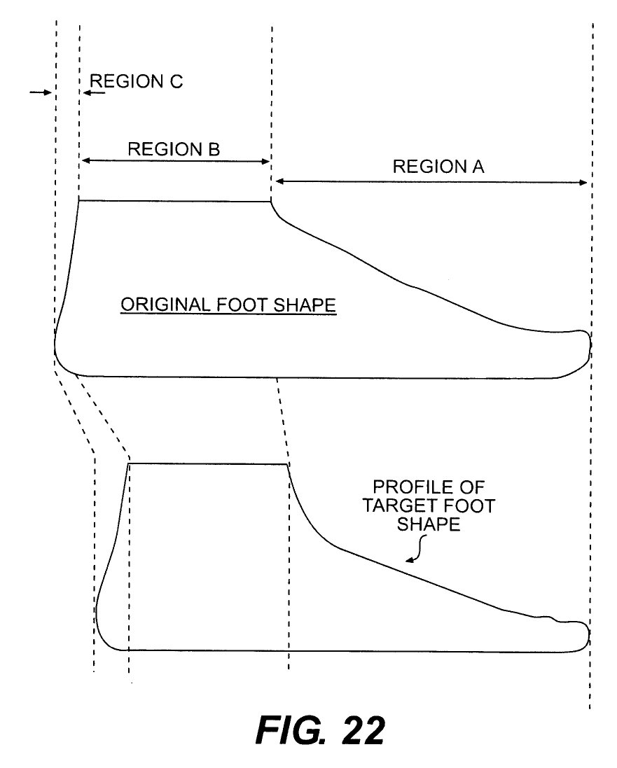

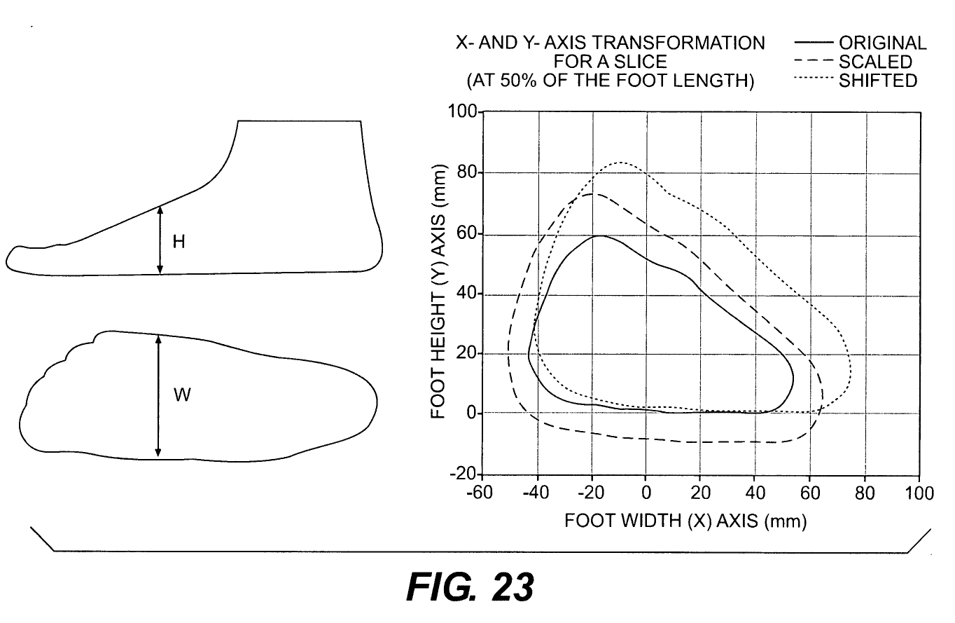

The generated mean foot shape will have the same size as the foot shapes in the database, which have all been scaled to the same size. Indeed, scaling of the foot shapes in the database to a predetermined size, enables several different foot shapes to be averaged to get the best approximation of the 3D shape of the photographed foot. However it is important that the 3D model of the photographed foot has not only the right shape, but also the right size. Therefore the next step is to adjust the real-time mean foot shape to have the correct size. This may be done by making reference to the parallel projection profiles 1509 of the photographed foot. The computer program 1513 transforms the real-time mean foot shape to fit the parallel projection profiles by a scaling process (1516). In the scaling process the x, y and z dimension of the 3D model of the foot (e.g. the 3D point cloud) are scaled to fit the 2D projections using standard scaling techniques. In order to enhance the accuracy of the process, the foot may be split into a plurality of sections for each dimension (x, y, z) and each section scaled separately. This is illustrated in FIGS. 22 and 23.

The scale transformed foot shape is then outputted as the final foot shape 1517. It is preferably output as 3D point cloud data or in a format readable by CAD software.

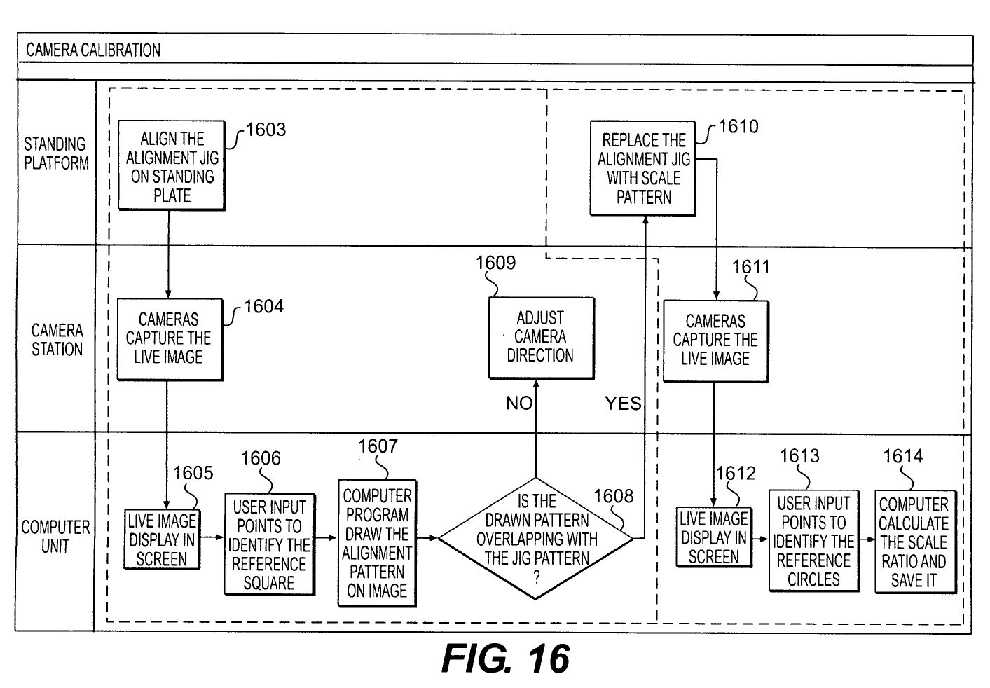

FIG. 16 shows the flow diagram of the camera calibration process. The camera calibration process is in two phases: the direction calibration 1601 and the scale calibration 1602.

In direction calibration 1601 for the left camera 603, the alignment jig 1301 is aligned with the foot length axis 301, with the alignment pattern 1302 facing the left side mirror 206. The left camera 603 will capture the image formed in the left side mirror 206 and the monitor 402 will display the captured image. The user enters several pre-defined points on the image to identify the alignment pattern 1302. The computer unit 104 will draw the same pattern on the monitor 402. The user checks whether the drawn pattern overlaps with the actual pattern on the image, and adjust the camera direction, if needed. The direction calibration processes 1601 for a.) the right camera 601, b.) the front camera 602 and c.) the bottom camera 604 are similar except that the direction of the alignment pattern 1302 should a.) face the right side mirror 205, b.) align with the calibration axis 302 and c.) face the bottom mirror 207.

The scale calibration process 1602 for left camera 603 requires the scale jig 1401 to be aligned in the same way as the alignment jig 1301. The user identifies the circle in the front plate 1402 and rear plate 1403 in the computer program using the mouse 401. The computer unit 104 is able to calculate the camera distance, camera location, pixel-to-millimeter scale ratio and perspective-to-parallel conversion factor. Thus both the scale (pixel to millimeter) and perspective correction (perspective to parallel conversion factor) are calculated using the same scale jig (the scale jig is also referred to as the perspective distortion correction device). The computer program will save these parameters into its storage for future use. The scale calibration processes 1602 for a.) the right camera 601, b.) the front camera 602 and c.) the bottom camera 604 are similar except that the direction of the front plate 1402 should a.) face the right side mirror 205, b.) align with the calibration axis 302 and c.) face the bottom mirror 207.

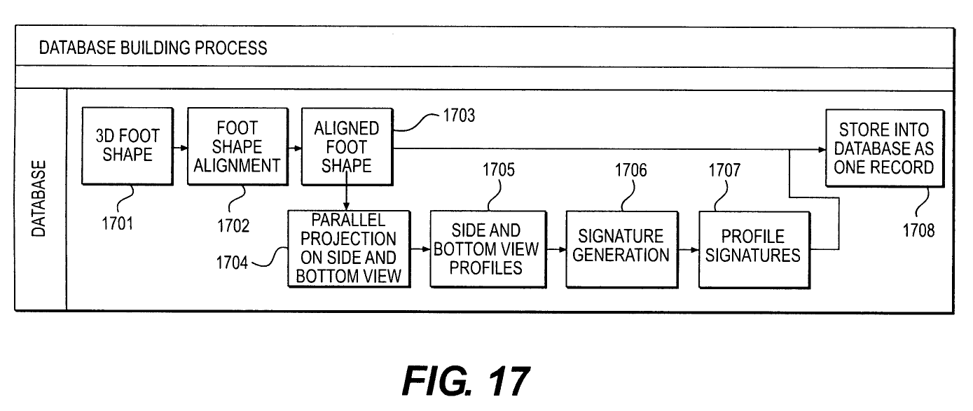

Referring to FIG. 17, a flow diagram of the foot shape database 1501 building process is shown. The 3D point cloud data file 1701 of foot shapes can be obtained using suitable technology mentioned in prior art. The 3D point cloud data file 1701 is preferably in ASCII XYZ file format. The user inputs each 3D point cloud data file 1701 into the database program. The database program aligns the foot shape (1702) defined by the 3D point cloud data file 1701 with a shape alignment algorithm and generates the aligned foot shape 1703. In this way all of the 3D point cloud data of the different feet are aligned to the same axes. The 3D point cloud (or other 3D representation) of the foot in each record is then scaled to a predetermined size (e.g. predetermined length). In this way the shapes of the different feet can be easily compared and it is possible to combine different feet having similar but different shapes, to arrive at an approximation of the photographed foot, without worrying about the different sizes of the feet in the database. The database program also projects the aligned foot shape 1703 into the side view and bottom view (1704) to produce the parallel projection profiles 1705. A signature 1707 for each foot is generated (1706)—e.g. from the turning function and arch height to length ratio of the foot. For each foot, the signature 1707 and the aligned foot shape 1703 are stored as one record in the database (1708).

The method described in this patent and also prior art methods such as laser scanners may be used to obtain foot shape. However, these methods do not allow the shape inside a shoe to be obtained, except in cases where the shoe is transparent. Typically these methods are carried out on a bare foot. However, the shape which a foot takes when inside a shoe is quite different to its neutral shape when barefoot on the ground. Therefore it is proposed to use a sock-like footwear to simulate the shape of the foot inside a shoe. This idea may be used with the camera based methods described in this application, but is not limited to that and may be used with laser scanning or other alternative methods. Since accuracy of current measurement devices is around ±0.5 mm, a seamless sock that can exert the ideal pressures is required for this purpose.

As described above, the idea is to provide an instrument for obtaining the preferable 3D shape of a foot inside a shoe in order to facilitate the footwear customization. Therefore, an In-shoe Shape Simulating Instrument (ISSI) preferably fulfills the following requirements: (i) be able to alter the foot shape to allow wearer to perceive the preferable footwear fit; (ii) be able to obtain a 3D shape using a 3D scanner; (iii) be able to determine the foot axis for registration; (iv) be reusable and easy to wash or clean; (v) be economical to produce

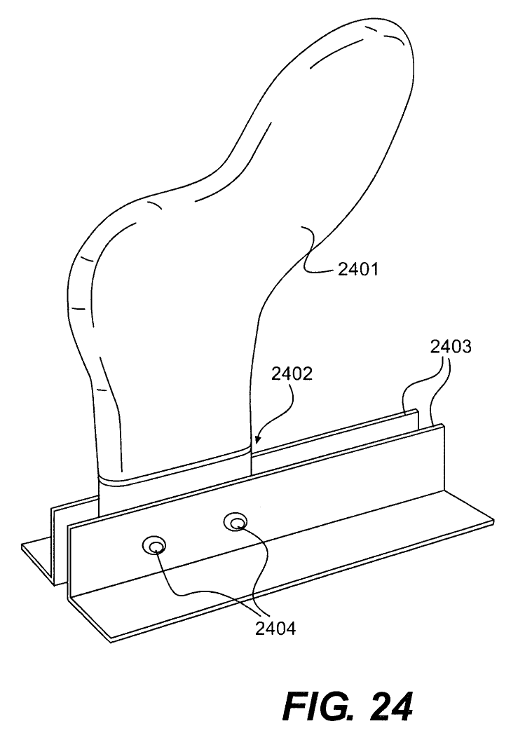

The idea of the ISSI may seem similar to present-day socks, but differs in that there are no seams, the material used and that the elastic returning force of the ISSI is stronger. Silicone has been used to produce seamless surgical gloves which are manufactured in one formed piece by dip-coating a solid hand-shaped mold to form a thin coating on the mold. The finished glove is then removed from the mold after curing. The inventors propose using the dip-coating technology to produce the seamless sock-like footwear, ISSI. A specific embodiment is now described by way of example. It is made of silicone, such as Elastosil® M 4600 (Wacker Silicones) with a thickness between 0.66 and 1.00 mm. In order to produce the ISSI with the specific shape, a sock-like aluminum mold of thickness 15 mm aluminum (FIG. 24) is used. The mold is specially shaped to simulate the foot inside of a shoe.

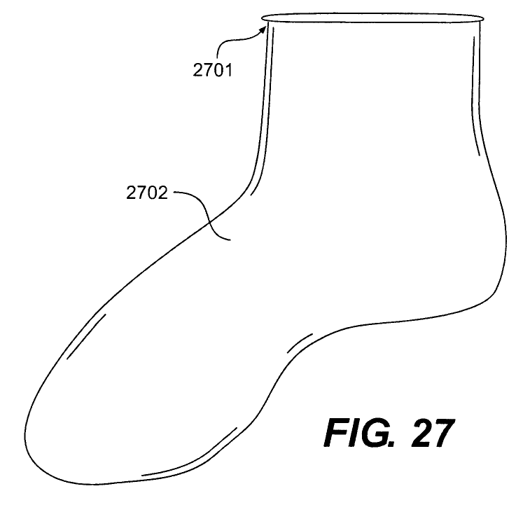

FIGS. 24-26 show the aluminum mold for making an ISSI. The finished ISSI made of silicon rubber is shown in FIG. 27. The aluminum mold with 15 mm thickness 2401 is supported by two pieces of L-shaped metal 2403 and firmed attached with each other by two screws 2404 and nuts 2602. The aluminum mold has a fillet edge with radius of 7.5 mm 2601 and a space with 1 mm depth and 2 mm width 2402 located at the base of the mold. Hence, the silicone rubber at the opening of the ISSI 2701 is thicker than the body of the ISSI 2702.

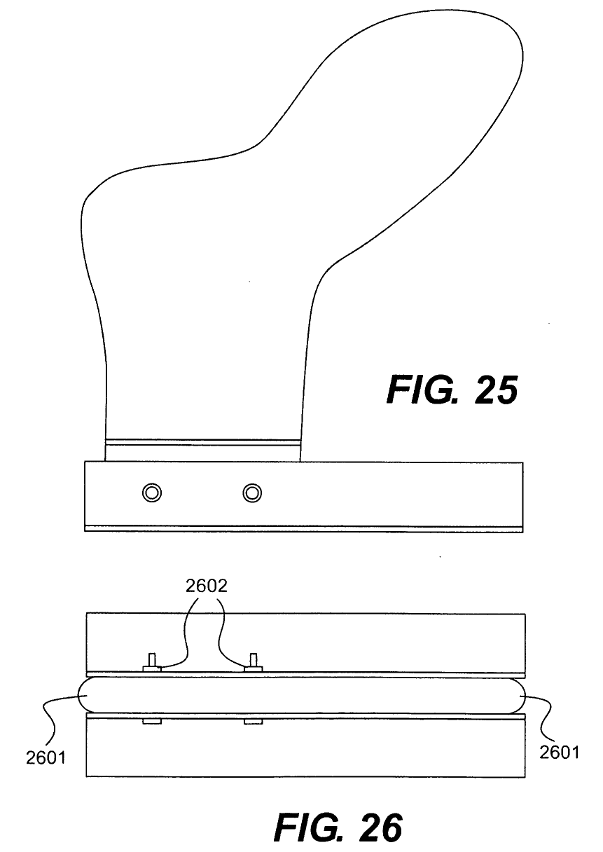

Due to the small production quantities, the dip-molding process used for producing ISSI is different from mass production. The following procedures are used to make the ISSI. The liquid silicone rubber, such as Elastosil® M 4600 (Wacker Silicones), is prepared by mixing 25 ml of silicone and 2.5 ml of curing agent. The mixture is poured along the edge of the mold, allowed to flow onto both sides of the mold and then spread evenly onto both sides of the mold within a period of two minutes. After that, the mold is attached to a motor and kept rotating in the anti-clockwise direction of FIG. 25 for 12 hours. Then, the finished ISSI is removed from the mold by cutting the cured silicone along the lower line of the space 2402. The finished ISSI is shown in FIG. 27.

The preferred embodiments of the invention described above may have any or all of the following advantages.

Firstly, comparing the photographs or projections to 3D images in a database, allows accurate generation of 3D data, from only a few 2D projections.

Secondly as cameras rather than laser scanners are used, the cost is less. Furthermore as only a few pictures are needed and the cameras can take pictures almost instantaneously, there is little delay compared to systems in which a laser has to scan over an entire foot or a single camera has to be moved to take dozens of pictures from different angles. Thus the probability of the foot moving and distorting the data is considerably reduced.

Thirdly, in preferred embodiments correction for perspective distortion allows accurate readings despite the fact that photographs are used. Furthermore, not only the profile of the bottom of the foot, but also the side profile and/or arch height to length ratio are taken into account, thus improving the fit.

The 3D foot shape data in the database is preferably scaled and aligned to same axes and size. This makes it possible to draw on a very large database of different feet to generate the 3D foot shape, as size is taken out of the equation during the comparison and real-time mean foot shape generation steps. The use of mirrors is convenient and allows all cameras to be placed in one location side by side or one on top of other. This allows for easy adjustment and replacement of the cameras. Finally the ISSI allows for accurate simulation of the foot shape inside the shoe.

1. A method of generating a 3D foot shape comprising the steps of:—
taking one or more photographs of the foot,
deriving foot shape data from the one or more photographs,
comparing the foot shape data to foot shape data of one or more foot shapes in a database and selecting one or more similar foot shapes from the database; and
generating a 3D foot shape for the photographed foot based on the one or more selected foot shapes.

2. The method of claim 1 wherein the photos include at least a photograph of the side of the foot and a photograph of the bottom of the foot.

3. The method of claim 1 wherein the foot shape data comprises one or more dimensions of the foot and/or one or more characteristic functions or values describing one or more 2D projections of the foot.

4. The method of claim 1 wherein the foot shape data comprises an arch length to arch height ratio for the foot.

5. The method of claim 1 wherein the foot shape data comprises a turning function of a 2D projection of the foot.

6. The method of claim 1 wherein the foot shapes in the database are scaled to a predetermined size.

7. The method of claim 1 further comprising the step of scaling the generated 3D foot shape to fit the size of the foot as determined from the one or more photographs.

8. The method of claim 3 wherein the one or more foot dimensions and/or 2D projections are adjusted to compensate for perspective distortion.

9. The method of claim 1 wherein the 3D foot shape is generated based on an average of a plurality of selected foot shapes from the database.

10. An apparatus for generating a 3D foot shape comprising;—
at least one camera,
a base for supporting a foot
a computer program for extracting foot shape data from the photograph,
a computer program for comparing the extracted foot shape data to foot shape data of one or more foot shapes stored in a database and selecting one or more similar foot shapes from the database; and
a computer program for generating a 3D foot shape of the photographed foot on the basis of the one or more selected foot shapes.

11. The apparatus of claim 10 wherein the foot shape data comprises one or more dimensions of the foot and/or one or more characteristic functions or values describing one or more 2D projections of the foot.

12. The apparatus of claim 10 wherein the apparatus comprises said database.

13. The apparatus of claim 10 wherein the database is remote from the apparatus.

14. The apparatus of claim 10 wherein the apparatus comprises at least a first camera for photographing the bottom surface of the foot and a second camera for photographing a side surface of the foot.

15. The apparatus of claim 10 wherein the apparatus comprises an arrangement of one or more mirrors for directing light reflected from a surface of the foot to said at least one camera.

16. The apparatus of claim 10 wherein the base has one or more alignment markings for facilitating alignment of a foot or calibration jig with the at least one camera.

17. The apparatus of claim 10 further comprising a perspective distortion correction module programmed to adjust the one or more photographs, or data derived from the one or more photographs, to compensate for perspective distortion.

18. The apparatus of claim 17 further comprising a perspective calibration device comprising a pair of predetermined images on parallel planes a predetermined distance apart from each other, a first one of said planes being non-opaque.

19. A method of generating a 3D foot shape comprising the steps of:—
taking one or more photographs of the foot,
deriving one or more foot dimensions and/or 2D projections from the one or more photographs,
and generating a 3D foot shape for the photographed foot based on a stored 3D model of a foot and resizing the stored 3D model to fit said one or more dimensions and/or 2D projections derived from the one or more photographs.

20. A method of measuring or digitizing a foot comprising placing the foot in a seamless molded sock which is designed to simulate the foot inside of a shoe and which is made from a single piece of elastic material, and then scanning or photographing the foot using an optical device.
